(19) United States
(12) Patent Application Publication
(10) Pub. No.: US 2010/0256873 A1
(43) Pub. Date: Oct. 7, 2010

(54) METHOD AND CONTROL UNIT FOR TRIGGERING OCCUPANT PROTECTION MEANS FOR A VEHICLE

(76) Inventors: Hoang Trinh, Ditzingen (DE); Ralf Walther, Bad Zwischenahn (DE)

Correspondence Address: KENYON & KENYON LLP, ONE BROADWAY, NEW YORK, NY, 10004, US

(21) Appl. No.: 12/664,658

(22) PCT Filed: May 16, 2008
(86) PCT No.: PCT/EP08/56063

§ 371 Date: May 19, 2010

(30) Foreign Application Priority Data
Jun. 14, 2007 (DE) 10 2007 027 492.2

(51) Int. Cl. B60R 21/0136

(52) U.S. Cl. 701/46; 701/45

(57) ABSTRACT

A method and a control unit for triggering occupant protection means as a function of a structure-borne noise signal are proposed. The occupant protection means are triggered as a function of the crash signal and the structure-borne noise signal, the structure-borne noise signal being evaluated beforehand as a function of at least one friction process which takes place in the vehicle structure.

### FIELD OF INVENTION

The present invention relates to a method and a control unit for triggering occupant protection means.

### BACKGROUND INFORMATION

German Patent Reference No. DE 3729019 A1 describes a device for deploying a safety device. By being associated with a structure-borne noise sensor, this device for deploying is capable of making a distinction between an impact against obstacles and other noises and interference under critical driving conditions, and for evaluating the impact. For example, a spectrum analyzer is used.

### SUMMARY

Embodiments of the present invention providing a method and control unit for triggering an occupant protection system for a vehicle is provided. For example, the occupant protection system is triggered as a function of a crash signal and the structure-borne noise signal or a quantity derived therefrom, the structure-borne noise signal being evaluated beforehand as a function of at least one friction process taking place in the vehicle structure.

In embodiments of the present invention, structure-borne noise signals occur in the event of a vehicle crash via different mechanisms such as deformation, rupture processes, and also via non-linear processes such as, for example, friction processes. These non-linear processes are difficult to reproduce. The velocity dependency is also non-linear.

In embodiments of the present invention, the interfering friction processes are identified in the crash so they may be eliminated in a targeted manner. In situations, interfering friction processes always take place in the same vehicle structure, for example, on the crossmember. In embodiments of the present invention, eliminating these structure-borne noise signals which occur due to the friction processes provides for an improved, earlier recognition of hard and soft crashes. In embodiments of the present invention, a better hierarchic discrimination of crashes may thus be made possible, for example, via different algorithm paths for the crash detection.

In embodiments of the present invention, the overall misuse robustness is also enhanced. A misuse is an impact which should not trigger any deployment, for example, a slight parking bump. Embodiments of the method and control unit of the present invention make it possible to omit an air pressure sensor system for lateral impact sensing or also peripheral acceleration sensors since, for example, embodiments of the present invention make rapid indication of the plausibility of an accident possible.

Embodiments of the method and control unit of the present invention improve the use of and provide a more solid base for structure-borne noise sensor signals for triggering occupant protection means. In embodiments, instead of a structure-borne noise signal, signals derived from the structure-borne noise signal such as, for example, the integrated structure-borne noise signal, may also be used.

In embodiments, triggering here means activating or deploying occupant protection system or means. Embodiments of the present invention provide for an occupant protection system which includes active and passive occupant protection means such as, for example, brakes, electronic stability program, airbags, seat belt tighteners, rollover bars, crash-active headrests, and the like.

In embodiments of the present invention, the structure-borne noise signal is the processed high-frequency signal of an acceleration sensor system, processing being understood as band-pass filtering and the determination of the envelopes, for example. In embodiments of the present invention, the quantity derived therefrom is, for example, the integrated structure-borne noise signal. In embodiments of the present invention, other processing methods may also be used to generate this quantity. In embodiments of the present invention, the quantity includes a plurality of individual signals which may also be generated differently from the structure-borne noise signal.

In embodiments of the present invention, the crash signals are signals of a crash sensor system such as an acceleration sensor system, an air pressure sensor system, a surroundings sensor system, or a structure-borne noise sensor system.

In embodiments of the present invention, a friction process is, as described previously, friction between vehicle structural components, which may result in high structure-borne noise signals. For example, in the case of a bolted joint between the crash box and the crossmember, the crossmember may additionally hit the crash box in the early crash phase, specifically due to the non-friction-locked contact, which may be caused due to the degree of freedom of the bolted joint in the longitudinal direction. However, other friction processes are also to be taken into account.

In embodiments of the present invention, vehicle structure is understood as the vehicle frame, that is, the chassis of the vehicle.

In embodiments of the present invention, evaluation is understood as a threshold value comparison, for example. In embodiments of the present invention, weighting, additions, or subtractions may also be understood as evaluation.

In embodiments of the present invention, the interfaces are designed here as hardware and/or software. In embodiments, a software interface may also be situated on a microcontroller as a software module or on another processor as the analyzer circuit in a control unit itself. In embodiments, the interface may have an integrated circuit, a plurality of integrated circuits, or discrete components, or a combination of an integrated circuit and discrete components.

In embodiments of the present invention, the analyzer circuit is a processor, for example, a microcontroller. Other processor types are also possible. Another integrated circuit, a structure of discrete components, or a plurality of integrated circuits, is also possible here.

In embodiments of the present invention, the evaluation module is a section of the analyzer circuit, so that there is hardware identification of the evaluation module. In embodiments of the present invention, the evaluation module is a software module, i.e., a program. In embodiments, this may also apply to the decision module.

In embodiments of the present invention, the evaluation takes place as a function of time and/or of a velocity and/or of a forward displacement, the at least one friction process being characterized thereby. In embodiments, the vehicle structure correlates with an intrusion, that is, a forward displacement. Thus, in embodiments, the structure-borne noise signal can be appropriately weighted or eliminated via this intrusion. Namely, in embodiments, the intrusion is a measure of how the collision object penetrates into the vehicle structure. This correlation makes model-based weighting of the structure-borne noise possible as a function of the actual vehicle structures such as the crossmember of the crash box and the side member, which are familiar with the vehicle structure. In embodiments, the structure-borne noise signal or a signal derived therefrom via the deformation path or intrusion is/are analyzed. Mapping or identification of structure-borne noise signals that occur from the deformation or the rupture processes of the corresponding vehicle structures thus becomes possible.

In embodiments of the present invention, the destruction of the vehicle structures is crash-specific and correlates with the severity of the crash. In embodiments, severity of the crash is understood as the consequences of the crash, for example, that in the event of a high-velocity impact the crash severity is higher than in the event of an impact having a lower crash severity and at a corresponding lower velocity, for example. In embodiments, the structure-borne noise signals may be weighted as a function of the vehicle structure via an intrusion-dependent threshold. In embodiments, weighting with the aid of the velocity reduction is effected, since the vehicle structures are designed to have different rigidities. In embodiments, the different structures result in different degrees of energy absorption. In embodiments, the evaluation of the structure-borne noise signal and a quantity derived therefrom as a function of time and/or the velocity and/or the forward displacement offers that in this case easily measurable or determinable quantities are available, for which there is a wealth of experience in the area of airbag electronics. In embodiments, the velocity is determined by integrating an acceleration signal, and the forward displacement is determined by double integration. As explained previously, the forward displacement and the velocity correlate with the friction process.

In embodiments of the present invention, using the time, velocity, and forward displacement quantities, a first threshold is established for the structure-borne noise signal or for a quantity derived therefrom and evaluation takes place as a function of a first threshold comparison. In embodiments, this means that the structure-borne noise signal must exceed a first threshold for it to have any effect on the main algorithm regarding the evaluation of the crash signal.

In embodiments, a second threshold for the crash signal is then analyzed as a function of the evaluation. In embodiments, this means that the structure-borne noise signal may be used with respect to its absolute value or the signal derived therefrom or a difference value between the threshold and the structure-borne noise signal for computing the second threshold. For example, this may be accomplished by using a so-called lookup table. Or, this may be accomplished by defining a formula to then compute and output a characteristic curve as a function of this formula. This formula may be based on empirical and/or analytical considerations.

In embodiments of the present invention, the evaluation takes place as a function of data about the vehicle structure, for example, about the type of connection between the crossmember and the crash box. This allows for better establishment of the threshold values for the crash signal and for the structure-borne noise signal or the signal derived therefrom. Deployments thus become more accurate. These data include, for example, the crash box information, the admissible load on the crash box, and the type of connection between the crossmember and the crash box. Other data may be used for this purpose. The data may have, for example, information about the type of connection between the crossmember and the crash box, and whether the connection is designed, for example, as a welded joint or a bolted joint.

In embodiments of the present invention, a distinction between a hard and a soft crash is made as a function of the structure-borne noise signal or a signal derived therefrom and the time and/or the velocity and/or the forward displacement. This makes a more accurate further processing of the signals already obtained. In embodiments, this distinction between a hard and a soft crash may directly affect the main algorithm in which the crash signal is used for decision-making regarding whether or not the occupant protection system is to be triggered. In embodiments, differentiating between a hard and a soft crash may also have an effect on the thresholds in this main algorithm. This determination may also be logically linked here to other results in the main algorithm.

In embodiments of the present invention, the distinction is made via a second threshold comparison with a third threshold of the structure-borne noise signal and a quantity derived therefrom. This third threshold for the second threshold comparison is formed as a function of the time and/or the velocity and/or the forward displacement. The thresholds may be established, as in the case of the first threshold, for example, by drawing the threshold in such a way that a high no-fire crash is just below this threshold and a low must-fire crash is just over this threshold. This means that the corresponding threshold is calibrated, for example, via a fitting program with the help of known quantities for the vehicle. The data about the no-fire crashes (e.g., misuse) and the must-fire crashes are available from experimental and/or simulated data.

In embodiments of the present invention, the first or second threshold comparison is used for a plausibility check of the triggering decision. This means that a check is made of whether or not the structure-borne noise signal or a quantity derived therefrom exceeds the corresponding threshold and a plausibility flag is set as a function of the check. In embodiments, this is then tested in the main algorithm.

### BRIEF DESCRIPTION OF THE DRAWINGS

FIG. 1 shows a block diagram of an example embodiment of a control unit in a vehicle according to the present invention.

FIG. 2 shows an example embodiment of software modules for the microcontrollers.

FIG. 3 shows an example signal flow chart.

FIG. 4 shows an example signal flow chart.

FIG. 5 shows a schematic of an example front of a vehicle.

FIG. 6 shows an example structure-borne noise signal or a structure borne noise signal feature in a time and velocity and forward displacement diagram.

FIG. 7 shows an example structure-borne noise signal or a structure borne noise signal feature in a time and velocity and forward displacement diagram.

FIG. 8 shows an example structure-borne noise signal or a structure borne noise signal feature in a time and velocity and forward displacement diagram.

### DETAILED DESCRIPTION

As discussed previously, structure-borne noise signals occur due to different mechanisms. In embodiments of the present invention, for impact detection, the mechanisms occurring due to the impact per se are useful such as, for example, the deformation or rupture processes. Friction processes, while they also occur as a result of the impact, may cover signals of other mechanisms such as deformation or rupture processes and thus make the analysis of the impact difficult or even impossible. For example, in the event of a so-called slow AZT crash at 15 km/h a deformation of the crossmember and the crash box may occur, which results in a significant structure-borne noise signal. On the other hand, in the event of a hard and high-velocity crash, for example, in a so-called US NCAP crash at 56 km/h, a very rapid and simultaneous destruction of the front components such as the crossmember and the crash box occur and, later, the side member and other vehicle structures are deformed.

In embodiments, the structure-borne noise occurring during the crash is a direct function of the structural property of the vehicle, the characteristic or the variation of the structure-borne noise signal being applicable in principle to any vehicles due to their very similar vehicle structure. In embodiments, the collapse of individual components such as the crash box is therefore a function of the velocity, joining methods such as a threaded joint or a welded joint between the crossmember and the crash box playing a prominent role, since they may result in friction processes.

In embodiments, the factors velocity and crossmember-crash box connection may cause a structure-borne noise signal or a quantity derived therefrom to have a higher result in the case of a so-called no-fire crash AZT compared to a must-fire crash ODB 40 in the most unfavorable case, so that a global, time-independent threshold for making a distinction between a deployment case and a non-deployment case may no longer suffice. In these cases, a more complex threshold which changes over time or with the velocity or the intrusion is used according to the present invention. In embodiments, other, more accurate methods such as a pattern detection or correlation techniques may be provided. If the friction processes are well-known a priori, such friction processes may also be masked, for example. Such masked signals may also be interpolated in the spectrum.

In embodiments, the derivation of the structure-borne noise signal, which is here identified as signal quantity or feature, is the first integral of the structure-borne noise signal, the integral being formed pragmatically, for example, as a window integral or also as a summation or filtering.

In embodiments, complex thresholds may also be established by linking the time, the velocity, and the intrusion or forward displacement.

The present invention makes it possible to replace peripheral acceleration sensors or air pressure sensors for side impact sensing or, for example, to substitute the acceleration sensor for the air pressure sensor.

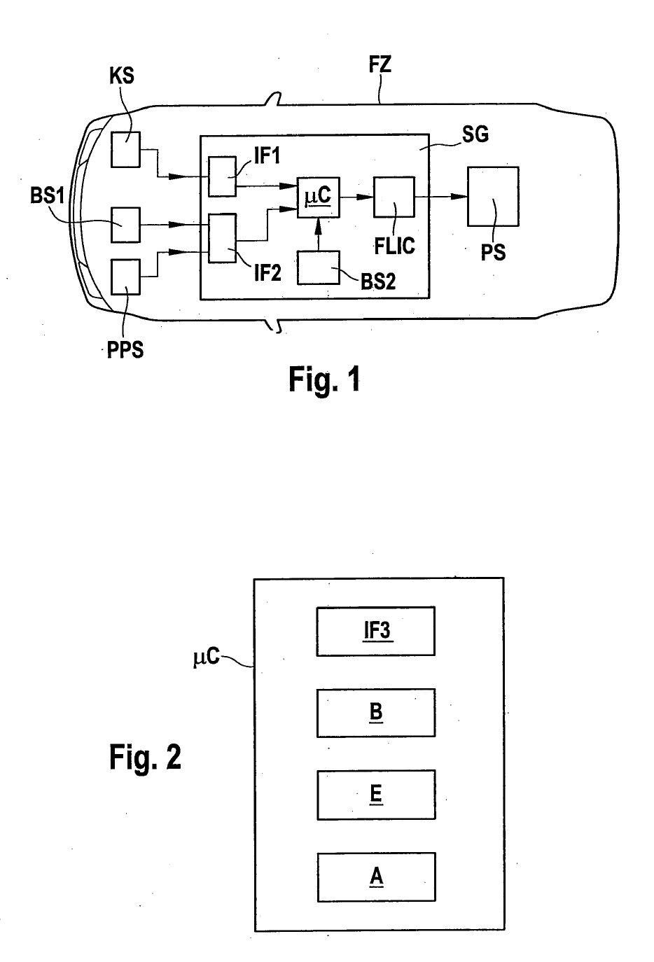

FIG. 1 shows control unit SG according to the present invention in vehicle FZ in a block diagram. A structure-borne noise sensor system KS located outside the housing of control unit SG is connected to a first interface IF1 of control unit SG. This structure-borne noise sensor system KS is an acceleration sensor system, which may also output high-frequency signals and thus the structure-borne noise or signal. Structure-borne noise sensor system KS may be located in control unit SG or in a sensor cluster. In an embodiment, location in another control unit may occur. An acceleration sensor system BS1 and an air pressure sensor system PPS as crash sensors are connected to a second interface IF2 for transmitting the crash sensor signals to second interface IF2. A second acceleration sensor system BS2 is situated in control unit SG in this example. In embodiments, the acceleration sensor system may be sensitive in different spatial directions. Air pressure sensor system PPS is situated in the lateral parts for detecting a side impact. Interfaces IF1, IF2, and acceleration sensor system BS2 are connected to a microcontroller μC as the analyzer circuit. Microcontroller μC determines whether or not triggering should occur as a function of these signals. If such triggering is to occur, a signal is transmitted to a triggering circuit FLIC, for example, via an SPI (Serial Peripheral Interface) bus. Triggering circuit FLIC, which is also present as an IC or a plurality of ICs or a combination of discrete components and ICs, then activates occupant protection means PS.

According to the present invention, microcontroller μC, using an evaluation module, evaluates the structure-borne noise signal or a quantity derived therefrom such as the first integral of the structure-borne noise signal, as a function of at least one friction process taking place in the vehicle structure. This is performed, for example, by using appropriate threshold comparisons with previously established thresholds or also adaptive thresholds or via pattern detection or correlation techniques or interpolation techniques. The structure-borne noise signal or the evaluated quantity derived therefrom thus evaluated is then supplied to a decision module to which crash signals are also supplied for deciding whether or not the occupant protection means are to be triggered. The evaluation module and the decision module are software modules in this case. In embodiments, these modules can be assigned to a separate piece of hardware, so that the evaluation module is made up of circuits and the decision module is made up of other circuits. These circuits may be situated on a single substrate or on different substrates.

Some components needed for operating the device, i.e., the control unit, have been omitted for the sake of simplicity. As explained previously, interfaces IF1 and 1F2 may also be designed as software, for example, on microcontroller μC itself.

FIG. 2 shows examples of software modules which are located on microcontroller μC. These include, for example, interface IF3 for connecting acceleration sensor BS2. Furthermore, evaluation module B, decision module E, and an analyzer module A are illustrated. Evaluation module B and decision module E perform the above-mentioned function. Analyzer module A then generates the triggering signal depending on the decision made by decision module E. Any structures regarding the software modules are possible here. However, these above-mentioned functions must be performed.

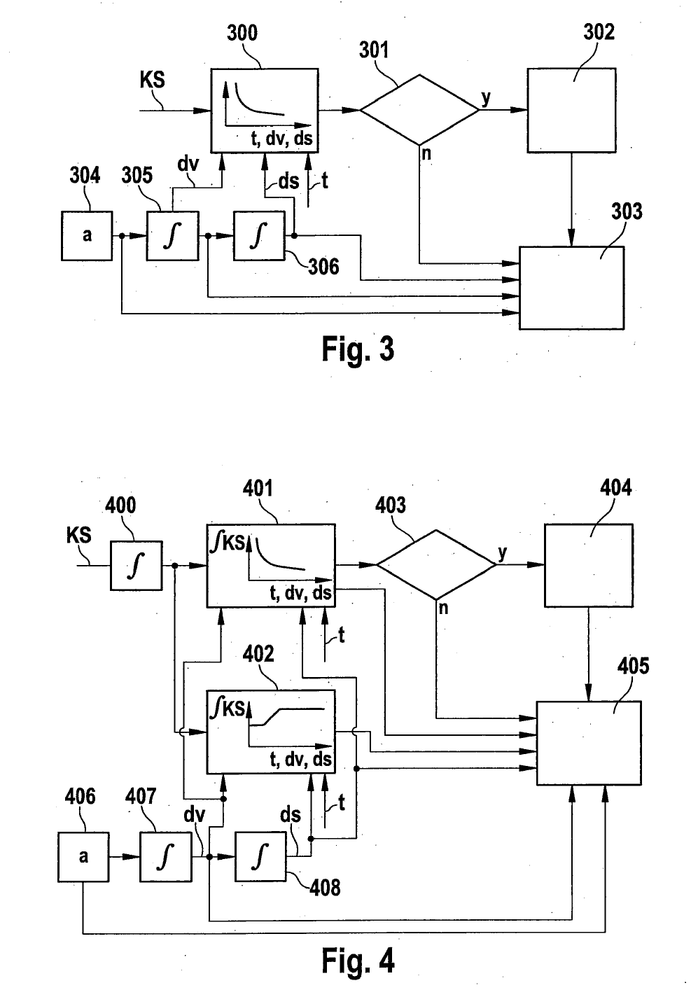

FIG. 3 shows a first signal flow chart to illustrate the method according to the present invention. Structure-borne noise signal KS is supplied to an evaluation module 300, which also receives other parameters, such as the time, the velocity, and the forward displacement. Velocity dv and forward displacement ds are determined by acceleration sensor system BS1, BS2 from acceleration 304 via simple 305 and double 306 integration, respectively. These quantities a, dv, and ds are also included in the main algorithm. Alternatively, only a subset of quantities a, dv, and ds is included in the main algorithm. Other quantities, not illustrated, are included in the main algorithm.

In embodiments, quantities t, dv, and/or ds define a characteristic curve with which structure-borne noise signal KS is compared. A check is then made in block 301 whether or not structure-borne noise signal KS is above the characteristic curve. If this is the case, a selection is made, in block 302 using the structure-borne noise signal or the difference between the structure-borne noise signal and the characteristic curve, which threshold is to be used in the main algorithm for the crash signal or the crash signals. This threshold is then used in main algorithm 303.

However, if it is established in block 301 that the structure-borne noise signal is below the threshold in evaluation module 300, this is also transmitted to the main algorithm and no threshold is selected as a function of the structure-borne noise signal.

FIG. 4 shows another signal flow chart indicating the variation compared to FIG. 3. Structure-borne noise signal KS is integrated once in block 400 here. A quantity derived from structure-borne noise signal KS, namely the first integral, is thus generated. This quantity is supplied to both block 401 and block 402. Block 401 has the same function as block 300, namely to decide whether or not structure-borne noise signal KS indicates a deployment case, by performing a threshold comparison as a function of time t and/or velocity dv and/or forward displacement ds. This is then checked in method step 403, where again, if the characteristic curve is exceeded in block 401, the threshold for main algorithm 405 is selected in block 404. If this is not the case, this result is relayed to main algorithm 405. However, now a signal is also relayed directly from block 401 to main algorithm 405 as a plausibility signal. By analyzing the structure-borne noise signal, an independent signal path is provided compared to the analysis of the crash signal. A plausibility check may be made using two such independent hardware paths.

Acceleration a, i.e., the low-frequency output signal of the acceleration sensor, in contrast with the high-frequency output signal, such as the structure-borne noise signal, is provided by one of the above-mentioned interfaces in block 406. Velocity dv is determined therefrom in block 407 by simple integration, and forward displacement ds is determined in block 408 therefrom by another simple integration. These quantities are supplied, as mentioned previously, to blocks 401 and 402. However, they are also supplied to main algorithm 405; not all quantities a, dv, ds, but only a subset, for example, dv and ds, may be supplied to main algorithm 405.

In an embodiment, using another threshold, a check is now made in block 402, with the help of the first integral of the structure-borne noise signal, of whether a hard or a soft crash has occurred. This characteristic curve may also be determined as a function of the time and/or the velocity and/or the forward displacement. In an embodiment, this result is also included in main algorithm 405 and may thus refine or check the analysis for plausibility in this main algorithm.

Other possible and reasonable combinations of FIGS. 3 and 4 are ascertainable in view of the present invention.

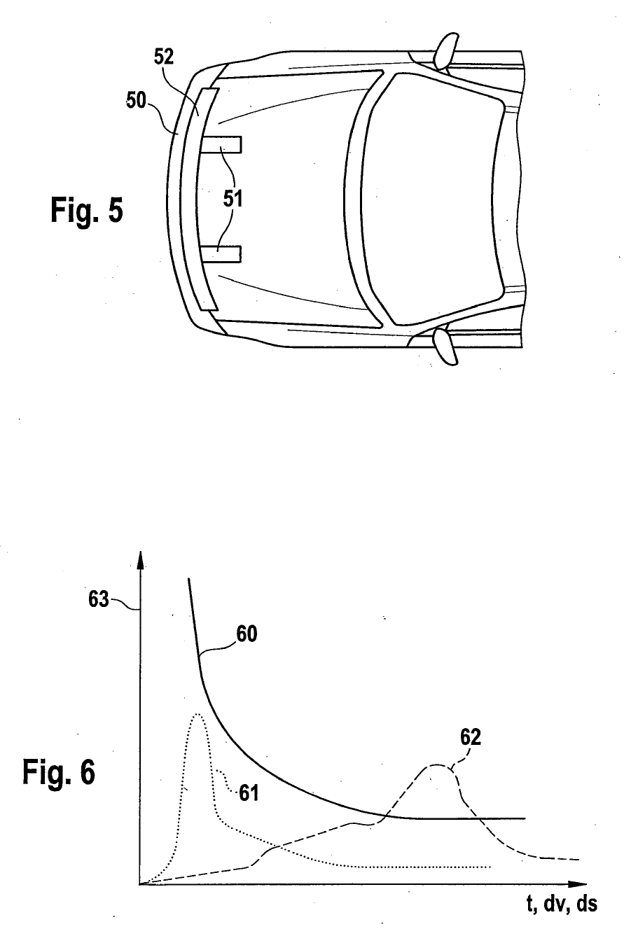

FIG. 5 schematically shows a vehicle front having a bumper 50, a crossmember 52, and crash boxes 51, which are built into crossmember 52. Crossmember 52 and crash boxes 51 may be joined by welding or bolts. In the case of a bolted joint, the friction signal may be of a substantial magnitude and must be taken into account according to the present invention.

FIG. 6 shows an example of a threshold which decides whether or not the structure-borne noise signal indicates a triggering crash. The threshold is labeled using reference numeral 60 and is established using crash tests. The structure-borne noise signal or the feature derived therefrom such as the first integral is plotted on ordinate 63. The time and/or the velocity and/or the forward displacement is plotted on the abscissa. A so-called no-fire crash 61 representing a so-called misuse, i.e., an impact which, however, should not result in any deployment of occupant protection means, is illustrated using a dotted line. Characteristic curve 60 is designed in such a way that a so-called no-fire crash 61 is situated just below it.

A so-called must-fire crash 62 which identifies such an impact which should cause the deployment of occupant protection means is illustrated using a dashed line. For this to occur, this must-fire crash 62 must be above characteristic curve 60, so that this evaluation using threshold 60 yields a deployment case being recognized.

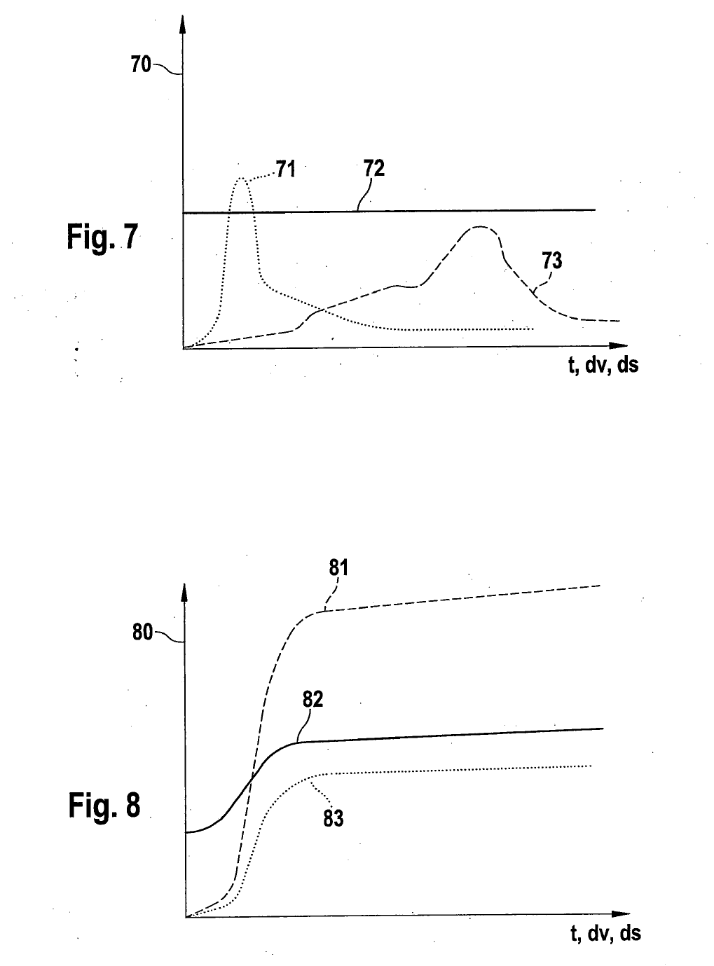

FIG. 7 shows a horizontal threshold 72 for structure-borne noise signal 70 on the ordinate for differentiating between a hard crash 71 and a soft crash 73. Both hard crash 71 and soft crash 73 may signify a deployment case. This information, however, is of great importance for triggering or evaluating the crash signal. A horizontal threshold is provided for the structure-borne noise signal. However, it is possible to provide this threshold with slopes.

FIG. 8 shows such a threshold, however, in this case it is for the structure-borne noise feature, namely the first integral of structure-borne noise signal 80. Threshold 82 is designed initially as an S curve and then transitions into a light slope. This characteristic curve is again established using crash tests, namely the greatest soft crash 83 from the smallest hard crash 81 is to be distinguished.

Since the signals do not immediately exceed the thresholds, monitoring over a certain period of time is necessary, which is established experientially. Crash tests are performed for this purpose.

What is claimed is:

1-10. (canceled)

11. A method for triggering occupant protection in a vehicle, comprising:
triggering occupant protection as a function of at least one of a structure-borne noise signal, a crash signal, a quantity derived from the structure-borne noise signal, and an evaluated quantity derived from the structure-borne noise signal,
wherein the evaluated quantity is a quantity derived from the structure-borne noise signal which is evaluated prior to the triggering as a function of at least one friction process occurring in association with a structure of the vehicle.

12. The method of claim 11, wherein the at least one friction process is characterized by a function of at least one of time, velocity, and forward displacement.

13. The method of claim 12, further comprising:
establishing a first threshold for one of the structure-borne noise signal and the quantity derived from the structure-borne noise signal by at least one of time, velocity, and forward displacement,
wherein the quantity derived from the structure-borne noise is evaluated as a function of a first threshold comparison.

14. The method of claim 11, wherein a second threshold for the crash signal is selected as a function of the evaluation.

15. The method of claim 11, wherein the evaluation takes place as a function of data on the vehicle structure.

16. The method of claim 15, wherein the data provide at least one connection between a crash box and a crossmember.

17. The method of claim 11, wherein distinction is made between a hard and a soft crash as a function of the structure-borne noise signal and the time and/or the velocity and/or the forward displacement

18. The method of claim 17, wherein the distinction is made via a second threshold comparison of the structure-borne noise signal or the quantity derived therefrom, a third threshold for the second threshold comparison being formed as a function of the time and/or the velocity and/or the forward displacement.

19. The method of claim 13, wherein a plausibility check of the triggering is made using at least one of the first and the second threshold comparisons.

20. A control unit for triggering occupant protection means for a vehicle, comprising:
a first interface which provides one of a structure-borne noise signal and a quantity derived from the structure-borne noise signal;
a second interface which provides a crash signal;
an analyzer circuit, including:
an evaluation module to evaluate one of the structure-borne noise signal and the quantity derived from the structure-borne noise signal as a function of at least one friction process which takes place in the vehicle structure, and
a decision module which decides the triggering as one of a function of the crash signal and the evaluated structure-borne noise signal, and a function of the crash signal and the quantity derived from the structure-borne noise signal.

21. The method of claim 18, wherein a plausibility check of the triggering is made using at least one of the first and second threshold comparisons.
